(19) United States
(12) Patent Application Publication
(10) Pub. No.: US 2026/0235817 A1
(43) Pub. Date: Aug. 13, 2026

(54) OPTICAL CONNECTOR AND METHOD FOR MANUFACTURING OPTICAL CONNECTOR

(71) Applicant: Fujikura Ltd., Tokyo (JP)

(72) Inventor: Ryoichi Mitobe, Sakura-shi (JP)

(73) Assignee: Fujikura Ltd., Tokyo (JP)

(21) Appl. No.: 19/463,551

(22) Filed: Jan. 29, 2026

(30) Foreign Application Priority Data
Feb. 7, 2025 (JP) 2025-019176

(51) Int. Cl. G02B 6/38

(52) U.S. Cl. CPC G02B 6/3858; G02B 6/3882

(57) ABSTRACT

An optical connector includes a ferrule having a connection end surface and a fiber hole on the connection end surface, an optical fiber inserted into the fiber hole, a biasing member that generates a biasing force against the ferrule, and a housing accommodating a part of the ferrule and the biasing member. The optical fiber is inserted into the biasing member. The biasing member includes a first member and a second member engaged with the first member. Each of the first member and the second member has a first wave-shaped elastic portion.

### CROSS-REFERENCE TO RELATED APPLICATIONS

The present application claims priority to Japanese Patent Application No. 2025-019176, filed on February 7, 2025, the contents of which are incorporated herein by reference in their entirety.

### BACKGROUND

### Technical Field

The present invention relates to an optical connector and a method for manufacturing an optical connector.

### Description of the Related Art

Japanese Unexamined Patent Application, First Publication No. 2017-102390 discloses a multi-fiber optical connector that is provided with a plurality of optical fibers. The multi-fiber optical connector includes a ferrule into which the plurality of optical fibers can be inserted. In addition, a biasing member for biasing the ferrule is disposed behind the ferrule. The biasing member is a compression coil spring, and the plurality of optical fibers are inserted inside the spring.

In the structure of Japanese Unexamined Patent Application, First Publication No. 2017-102390, when the optical connector is assembled, first, the optical fibers are inserted into the biasing member (the compression coil spring), and then the optical fibers are inserted into the ferrule. In this case, in a state where the biasing member is provided, a step of inserting the optical fibers into the ferrule, a subsequent polishing step of the ferrule, an inspection step, and the like are performed. Therefore, in order to prevent the biasing member from interfering with the ferrule or to prevent the optical fiber from being broken by the biasing member during the above-described step, it is necessary to retract the biasing member. In this manner, there is room for improvement in efficiency in the assembly of the optical connector.

### SUMMARY

One or more embodiments provide an optical connector and a method for manufacturing an optical connector, in which it is possible to improve assembly efficiency of the optical connector.

An optical connector according to one or more embodiments includes a ferrule that has a connection end surface and a fiber hole that is open on the connection end surface, an optical fiber that is inserted into the fiber hole, a biasing member that is configured to generate a biasing force against the ferrule, and into which the optical fiber is inserted, and a housing that houses part of the ferrule and the biasing member inside, in which the biasing member includes a first member and a second member that is engaged with the first member, and each of the first member and the second member has a wave-shaped elastic portion.

In addition, the optical connector may further include a guide pin that is inserted into the ferrule, in which the biasing member may have a pin clamp portion that clamps the guide pin, each of the first member and the second member may have a tip portion that configures the pin clamp portion, and the tip portion and the elastic portion may be integrally formed.

In addition, in the optical connector, the elastic portion may be made of resin or metal.

In addition, in the optical connector, the first member and the second member may have the same shape.

In addition, in the optical connector, each of the first member and the second member may include the elastic portion and a wave-shaped second elastic portion having a spring constant higher than a spring constant of the elastic portion, and may be configured such that the elastic portion first completes elastic deformation and then the second elastic portion continues the elastic deformation.

A method for manufacturing an optical connector according to one or more embodiments includes preparing an optical fiber, a ferrule having a fiber hole, and a first member and a second member each having a wave-shaped elastic portion, inserting the optical fiber into the fiber hole, polishing an end surface of the ferrule, and disposing the first member and the second member such that the optical fiber is sandwiched therebetween and causing the first member and the second member to be engaged with each other, after the polishing of the end surface.

According to one or more embodiments, it is possible to provide an optical connector and a method for manufacturing an optical connector, in which it is possible to improve assembly efficiency of the optical connector.

### BRIEF DESCRIPTION OF THE DRAWINGS

FIG. 1 is a perspective view of an optical connector according to a first example.

FIG. 2 is a sectional view of the optical connector according to the first example.

FIG. 3 is a perspective view of a biasing member according to the first example.

FIGS. 4A and 4B are perspective views of a first member of the biasing member according to the first example.

FIGS. 5A and 5B are diagrams for describing a method for manufacturing the optical connector according to the first example.

FIG. 6 is a sectional view of an optical connector according to a second example.

FIGS. 7A and 7B are perspective views of a first member of a biasing member according to the second example.

### DESCRIPTION OF THE EMBODIMENTS

### First Example

Hereinafter, an optical connector of a first example will be described based on the drawings.

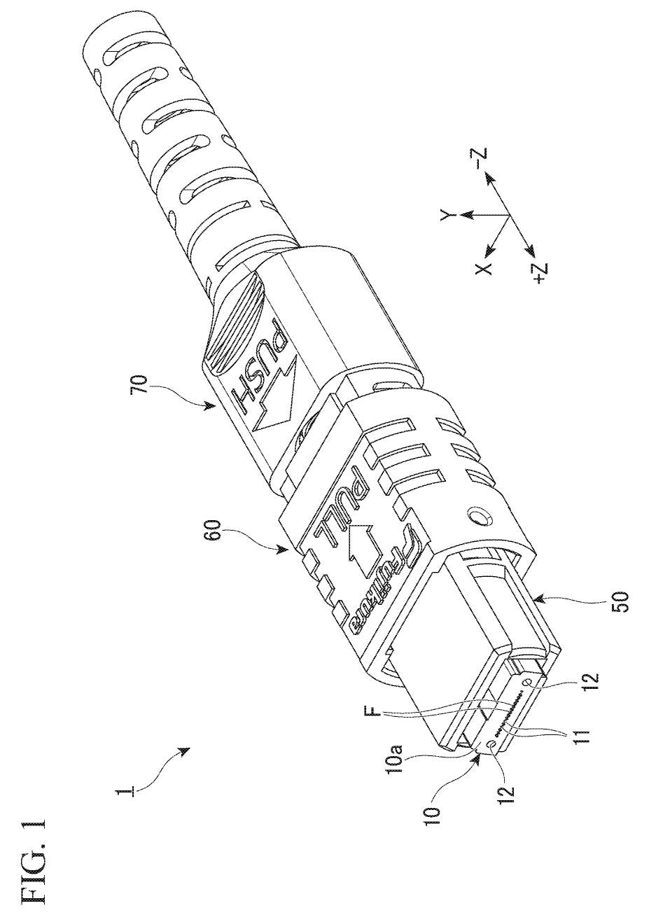

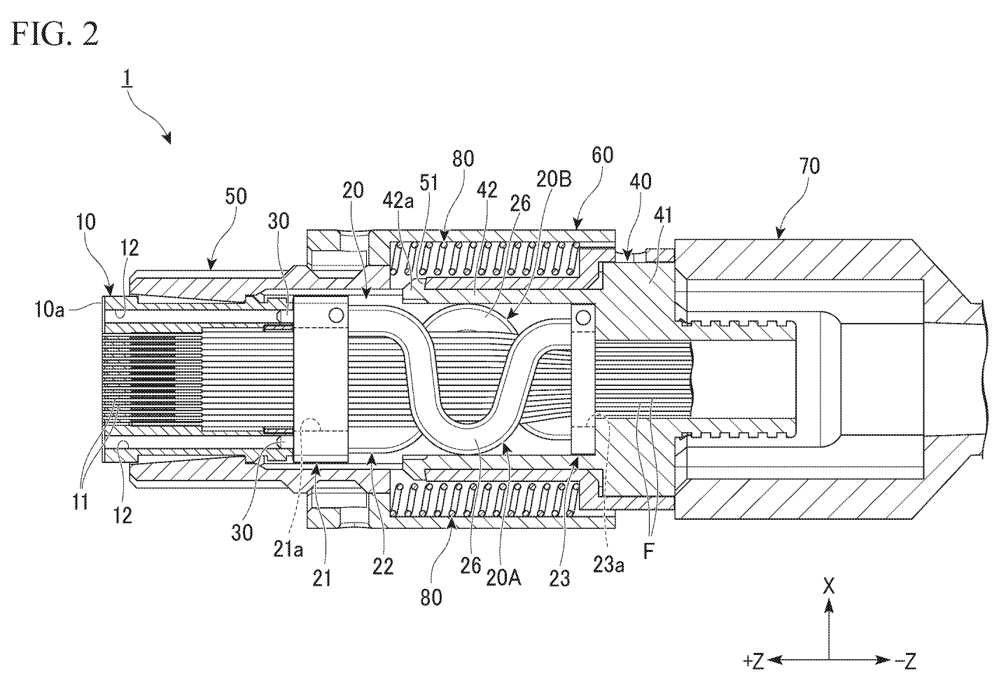

As shown in FIGS. 1 and 2, an optical connector 1 includes a ferrule 10, a biasing member 20, two guide pins 30, a spring push 40, a housing 50, a movable member (push-pull) 60, a boot 70, and a plurality of optical fibers F. A plurality of fiber holes 11 arranged in a row are formed in the ferrule 10. However, the fiber holes 11 may be arranged in a plurality of rows. Alternatively, the number of the fiber holes 11 provided in the ferrule 10 may be one.

The ferrule 10 has a connection end surface 10a. The fiber holes 11 are open on the connection end surface 10a. The optical fibers F are inserted into the fiber holes 11, respectively. The optical fiber F is exposed on the connection end surface 10a. A connection end surface of another optical connector comes into contact with the connection end surface 10a, so that the optical connector 1 can be optically connected to the other optical connector. However, the optical fibers F do not need to be inserted into some of the fiber holes 11 of the ferrule 10. That is, the number of the optical fibers F may be less than the number of the fiber holes 11.

### Direction Definition

A direction in which the plurality of fiber holes 11 extend is referred to as a longitudinal direction Z. The connection end surface 10a side (a +Z side) in the longitudinal direction Z is referred to as a front side or a tip side. The opposite side (a -Z side) is referred to as a rear side or a base end side. A direction in which the fiber holes 11 are arranged in a row is referred to as a first direction X. The first direction X is orthogonal to the longitudinal direction Z. A direction orthogonal to both the first direction X and the longitudinal direction Z is referred to as a second direction Y.

Two positioning holes 12 are formed in the ferrule 10. The two positioning holes 12 are disposed such that the plurality of fiber holes 11 are sandwiched therebetween in the first direction X. The optical connector 1 of the present example is female, and the relative position between the optical connector 1 and another connector is determined by inserting the positioning pins of the other connector into the positioning holes 12. However, the optical connector 1 may be male. That is, the optical connector 1 may have a positioning pin.

The optical fiber F is inserted into the fiber hole 11 and extends from the ferrule 10 toward the base end side (in a direction opposite to the connection end surface 10a). The plurality of optical fibers F are inserted into the biasing member 20. In addition, the plurality of optical fibers F are also inserted inside the spring push 40 and inside the boot 70.

The biasing member 20 is disposed between the ferrule 10 and the spring push 40. The biasing member 20 is made of, for example, resin or metal. The biasing member 20 has a function of applying a biasing force to the ferrule 10 to bias the ferrule 10 toward the tip side.

The biasing member 20 includes a pin clamp portion 21, a biasing portion 22, and a support portion 23. The pin clamp portion 21, the biasing portion 22, and the support portion 23 are disposed in this order from the tip side. The pin clamp portion 21 is in contact with the ferrule 10. The pin clamp portion 21 has an insertion hole 21a into which the plurality of optical fibers F are inserted. The support portion 23 is in contact with a main body portion 41 (described later) of the spring push 40. The support portion 23 has an insertion hole 23a into which the plurality of optical fibers F are inserted. The biasing portion 22 is compressed (elastically deformed) between the pin clamp portion 21 and the support portion 23. In this way, the biasing portion 22 generates a biasing force toward the tip side. The biasing force of the biasing portion 22 is transmitted to the ferrule 10 via the pin clamp portion 21.

The guide pin 30 has a substantially cylindrical shape. The two guide pins 30 protrude from a tip surface of the pin clamp portion 21 toward the tip side (the +Z side). The two guide pins 30 are inserted into the two positioning holes 12 of the ferrule 10, respectively, so that the relative position between the ferrule 10 and the biasing member 20 (the pin clamp portion 21) is determined. Since the optical connector 1 of the present example is female, the guide pin 30 does not protrude from the connection end surface 10a of the ferrule 10 toward the tip side. The optical connector 1 may be male, and the guide pin 30 as the positioning pin may protrude from the connection end surface 10a of the ferrule 10 toward the tip side.

The two guide pins 30 are held by the pin clamp portion 21. In the present example, the two guide pins 30 are formed integrally with the pin clamp portion 21. For example, in a case where the optical connector 1 is male, the guide pin 30 may be formed separately from the pin clamp portion 21. In this case, two guide pin holding holes are open on the tip surface of the pin clamp portion 21, and rear end portions of the guide pins 30 may be inserted into the guide pin holding holes, so that the guide pins 30 may be held by the pin clamp portion 21. In addition, a pin support plate that supports the guide pin 30 may be provided between the ferrule 10 and the pin clamp portion 21.

The spring push 40 receives a reaction force (a force toward the -Z side) of the biasing force generated by the biasing member 20, and supports the reaction force. The spring push 40 has the main body portion 41 and a pair of engaging claws 42. The main body portion 41 supports the biasing member 20 from the base end side. The pair of engaging claws 42 extend from the main body portion 41 toward the tip side. An engaging protrusion 42a that protrudes toward the outside in the first direction X is formed at a tip of each of the pair of engaging claws 42. The engaging protrusion 42a is engaged with an engaging portion 51 (described later) of the housing 50.

The housing 50 houses part of the ferrule 10 and the biasing member 20 inside. Part of the ferrule 10 protrudes from the housing 50 toward the tip side. The ferrule 10 is movable to the base end side against the biasing force of the biasing member 20. Specifically, when the optical connector 1 is connected to another connector, the ferrule 10 is pushed toward the base end side by the ferrule of the other connector. In this way, the ferrule 10 is moved to the base end side with respect to the housing 50.

The engaging portion 51 that is engaged with the engaging protrusion 42a is formed at each of both end portions of the housing 50 in the first direction X. In the present example, the engaging portion 51 is a hole that penetrates the housing 50 in the first direction X, and the engaging protrusion 42a of the spring push 40 is inserted into the engaging portion 51. The engaging portion 51 and the engaging protrusion 42a are engaged with each other in this manner, so that the movement of the spring push 40 toward the base end side with respect to the housing 50 beyond a predetermined position is restricted.

The movable member 60 is disposed to surround the housing 50 from the outside. A pair of second biasing members 80 is disposed inside the movable member 60. The second biasing member 80 is disposed between the housing 50 and the movable member 60 and biases the movable member 60 toward the tip side. Although a detailed description is omitted, the movable member 60 is a portion that is operated when the optical connector 1 is pulled out from an adapter or the like.

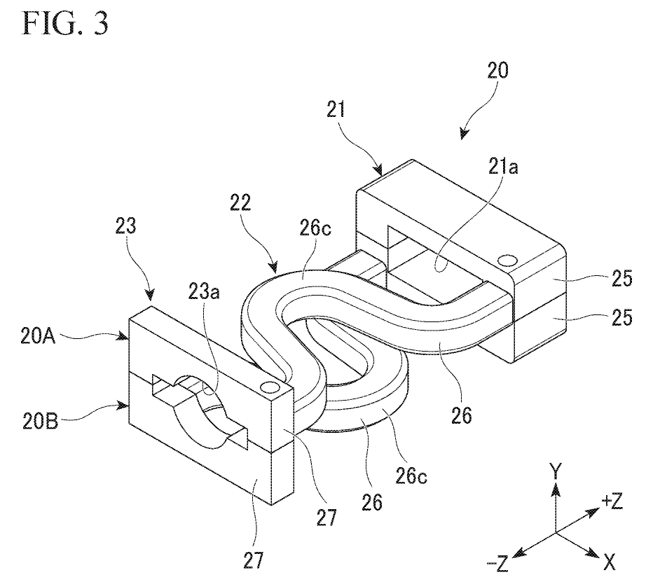

As shown in FIG. 3, the biasing member 20 can be divided into a first member 20A and a second member 20B. In the example shown in the drawing, the biasing member 20 (the first member 20A and the second member 20B) is divided along a plane orthogonal to the second direction Y. The first member 20A and the second member 20B are disposed such that the plurality of optical fibers F are sandwiched therebetween in the second direction Y. The first member 20A and the second member 20B are engaged with each other to configure the biasing member 20. The first member 20A and the second member 20B have the same shape. Hereinafter, the configuration of the first member 20A will be described. However, this description is also applied to the second member 20B.

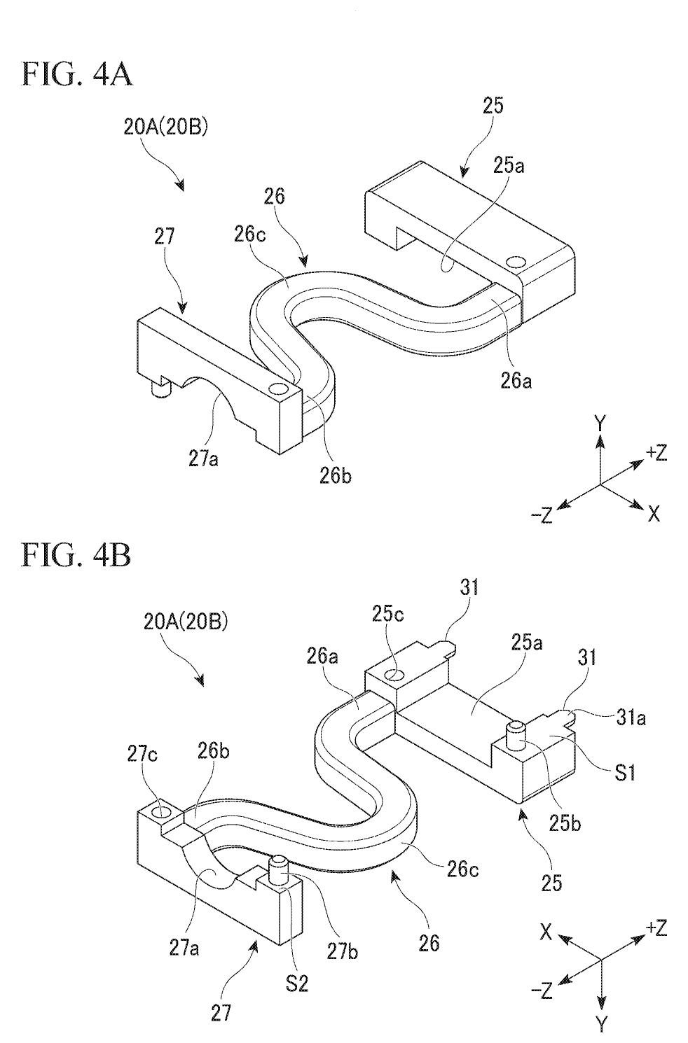

As shown in FIGS. 4A and 4B, the first member 20A (the second member 20B) has a tip portion 25, an elastic portion 26, and a base end portion 27. The tip portion 25, the elastic portion 26, and the base end portion 27 are disposed in this order from the tip side. The tip portion 25, the elastic portion 26, and the base end portion 27 are integrally formed.

The tip portion 25 has a substantially rectangular parallelepiped shape. The pin clamp portion 21 is configured by the tip portions 25 of the first member 20A and the second member 20B. The tip portion 25 has a facing surface S1 facing the second direction Y. When the first member 20A and the second member 20B are engaged with each other, the facing surfaces S1 of the first member 20A and the second member 20B come into contact with each other. A recessed portion 25a that is recessed from the facing surface S1 is formed in a central portion in the first direction X of the tip portion 25. The recessed portion 25a is formed over the entire length in the longitudinal direction Z of the tip portion 25. The insertion hole 21a of the pin clamp portion 21 is configured by the recessed portions 25a of the first member 20A and the second member 20B.

In addition, two guide pin pieces 31 each having a substantially semi-cylindrical shape are provided on the tip portion 25 to protrude from a tip surface of the tip portion 25 toward the tip side (the +Z side). The guide pin piece 31 is formed integrally with the tip portion 25. A side surface 31a of the guide pin piece 31 is flush with the facing surface S1. The two guide pin pieces 31 are disposed on both sides of the recessed portion 25a in the first direction X. The guide pin 30 is configured by the guide pin pieces 31 provided in the first member 20A and the second member 20B.

The base end portion 27 has a substantially rectangular parallelepiped shape. The support portion 23 is configured by the base end portions 27 of the first member 20A and the second member 20B. The base end portion 27 has a facing surface S2 facing the second direction Y. When the first member 20A and the second member 20B are engaged with each other, the facing surfaces S2 of the first member 20A and the second member 20B come into contact with each other. A recessed portion 27a that is recessed from the facing surface S2 is formed in a central portion in the first direction X of the base end portion 27. The recessed portion 27a is formed over the entire length in the longitudinal direction Z of the base end portion 27. The insertion hole 23a of the support portion 23 is configured by the recessed portions 27a of the first member 20A and the second member 20B.

A pin 25b protruding from the facing surface S1 is formed at one end portion in the first direction X of the tip portion 25, and a pin hole 25c recessed from the facing surface S1 is formed at the other end portion thereof. The pin hole 25c has a shape corresponding to the pin 25b. A pin 27b protruding from the facing surface S2 is formed at one end portion in the first direction X of the base end portion 27, and a pin hole 27c recessed from the facing surface S2 is formed at the other end portion thereof. The pin hole 27c has a shape corresponding to the pin 27b. The pin 25b of one of the first member 20A and the second member 20B is inserted into the pin hole 25c of the other of the first member 20A and the second member 20B, and the pin 27b of one of the first member 20A and the second member 20B is inserted into the pin hole 27c of the other of the first member 20A and the second member 20B. In this way, the first member 20A and the second member 20B are engaged with each other.

The elastic portion 26 has a wave shape. The elastic portion 26 is elastically deformable in the longitudinal direction Z. Specifically, the elastic portion 26 includes a first connection portion 26a that is connected to the tip portion 25, a second connection portion 26b that is connected to the base end portion 27, and a curved portion 26c that is disposed between the first connection portion 26a and the second connection portion 26b and curved in a wave shape (for example, a sinusoidal wave shape) along a plane orthogonal to the second direction Y. In the first member 20A (the second member 20B), the first connection portion 26a and the second connection portion 26b are disposed on one side in the first direction X. The curved portion 26c is curved to protrude toward the other side in the first direction X. The biasing portion 22 is configured by the elastic portions 26 of the first member 20A and the second member 20B. As shown in FIG. 3, in the biasing portion 22, the elastic portion 26 of the first member 20A and the elastic portion 26 of the second member 20B are disposed such that the curved portions 26c protrude in opposite directions to each other.

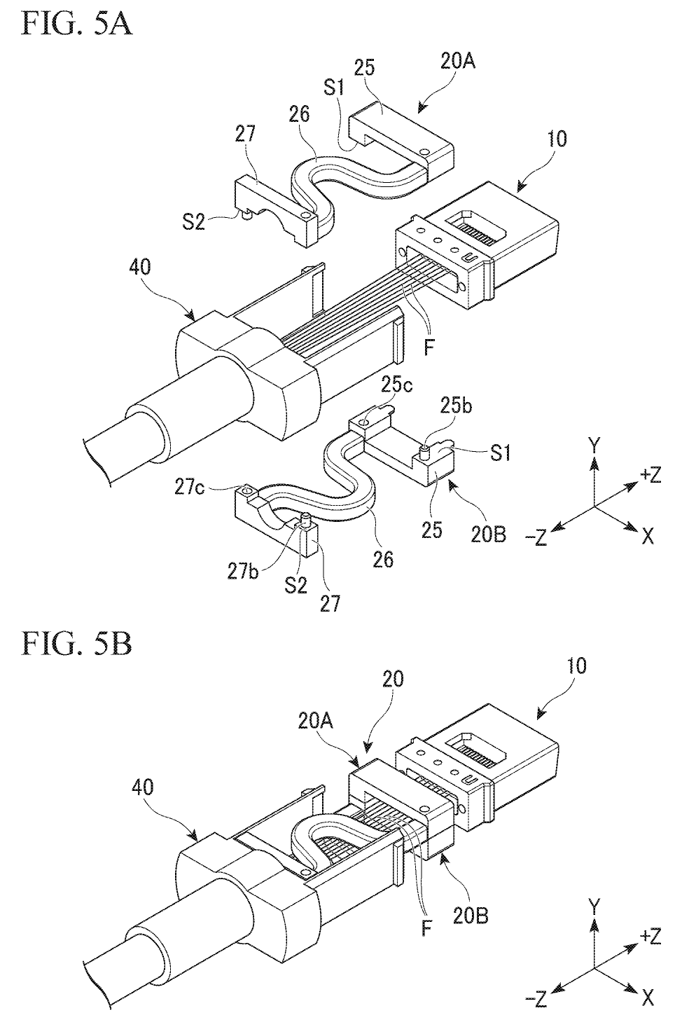

Next, a method for manufacturing (a method for assembling) the optical connector 1 will be described with reference to FIGS. 5A and 5B. The method for manufacturing the optical connector 1 according to the present example includes a preparing step, an optical fiber inserting step, a ferrule polishing step, and a biasing member disposing step.

In the preparing step, the optical fiber F, the ferrule 10, the first member 20A, the second member 20B, and the spring push 40 are prepared.

Next, in the optical fiber inserting step, after the plurality of optical fibers F are inserted into the spring push 40, the plurality of optical fibers F are inserted into the plurality of fiber holes 11 of the ferrule 10, respectively. Thereafter, the optical fibers F are fixed to the ferrule 10, for example, by injecting an adhesive into the fiber holes 11 and solidifying the adhesive.

Next, in the ferrule polishing step, the end surface of the ferrule 10 is polished to form the connection end surface 10a. In addition, the ferrule 10 may be washed, inspected, or the like, as necessary.

Next, in the biasing member disposing step, as shown in FIG. 5A, the first member 20A and the second member 20B are disposed such that the plurality of optical fibers F are sandwiched therebetween in the second direction Y between the ferrule 10 and the spring push 40. At this time, the facing surfaces S1 of the first member 20A and the second member 20B face each other, and the facing surfaces S2 face each other. The pins 25b and 27b of one of the first member 20A and the second member 20B are inserted into the pin holes 25c and 27c of the other of the first member 20A and the second member 20B, so that the first member 20A and the second member 20B are engaged with each other, as shown in FIG. 5B. In this way, the biasing member 20 is disposed between the ferrule 10 and the spring push 40.

Thereafter, the housing 50, the movable member 60, and the boot 70 are mounted, so that the manufacturing (assembly) of the optical connector 1 is completed.

As described above, the optical connector 1 according to the present example includes the ferrule 10 having the connection end surface 10a and the fiber hole 11 that is open on the connection end surface 10a, the optical fiber F that is inserted into the fiber hole 11, the biasing member 20 that is configured to generate a biasing force against the ferrule 10, and into which the optical fiber F is inserted, and the housing 50 that houses part of the ferrule 10 and the biasing member 20 inside. The biasing member 20 includes the first member 20A and the second member 20B that is engaged with the first member 20A. Each of the first member 20A and the second member 20B has a wave-shaped elastic portion 26.

The method for manufacturing the optical connector 1 according to the present example includes preparing the optical fiber F, the ferrule 10 having the fiber hole 11, and the first member 20A and the second member 20B each having the wave-shaped elastic portion 26, inserting the optical fiber F into the fiber hole 11, polishing the end surface of the ferrule 10, and disposing the first member 20A and the second member 20B such that the optical fiber F is sandwiched therebetween and causing the first member 20A and the second member 20B to be engaged with each other, after the polishing of the end surface.

According to the above-described configuration, after the optical fiber F is inserted into the ferrule 10, the first member 20A and the second member 20B are disposed such that the optical fiber F is sandwiched therebetween and are engaged with each other, such that the biasing member 20 can be disposed. According to such a procedure, it is possible to perform a step of inserting the optical fiber F into the ferrule 10, a subsequent step of polishing the ferrule 10, and the like, in a state where the biasing member 20 is not provided. Therefore, it is not necessary to consider the handling of the biasing member 20 in the above-described steps, and the assembly efficiency of the optical connector 1 can be improved.

In addition, the optical connector 1 further includes the guide pin 30 that is inserted into the ferrule 10. The biasing member 20 has the pin clamp portion 21 that clamps the guide pin 30. Each of the first member 20A and the second member 20B has the tip portion 25 configuring the pin clamp portion 21, and the tip portion 25 and the elastic portion 26 are integrally formed. According to this configuration, the pin clamp portion 21 that clamps the guide pin 30 can be easily manufactured. In addition, since the pin clamp portion 21 can be disposed after the optical fiber F is inserted into the ferrule 10, the assembly efficiency of the optical connector 1 can be further improved.

In addition, the elastic portion 26 is made of resin or metal. According to this configuration, for example, the first member 20A and the second member 20B are fabricated by injection molding, and thus the biasing member 20 can be easily and accurately manufactured.

In addition, the first member 20A and the second member 20B have the same shape. According to this configuration, for example, in a case where the first member 20A and the second member 20B are injection-molded, the first member 20A and the second member 20B can be fabricated by using the same mold, and thus the biasing member 20 can be easily manufactured. In addition, the elastic portion 26 of the first member 20A and the elastic portion 26 of the second member 20B are disposed to have wave shapes in opposite directions to each other, so that the ferrule 10 can be biased in a well-balanced manner by the elastic portions 26 of the first member 20A and the second member 20B.

### Second Example

Next, a second example according to one or more embodiments will be described. The basic configuration thereof is the same as that of the first example. Therefore, the same configurations will be denoted by the same reference numerals, the description thereof will be omitted, and only the different points will be described.

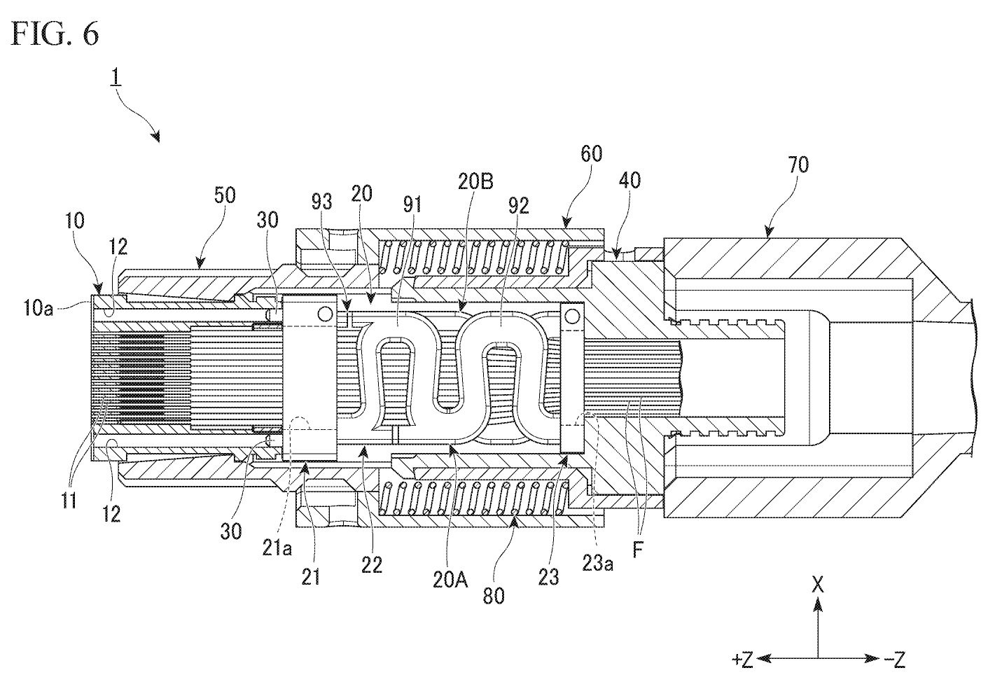

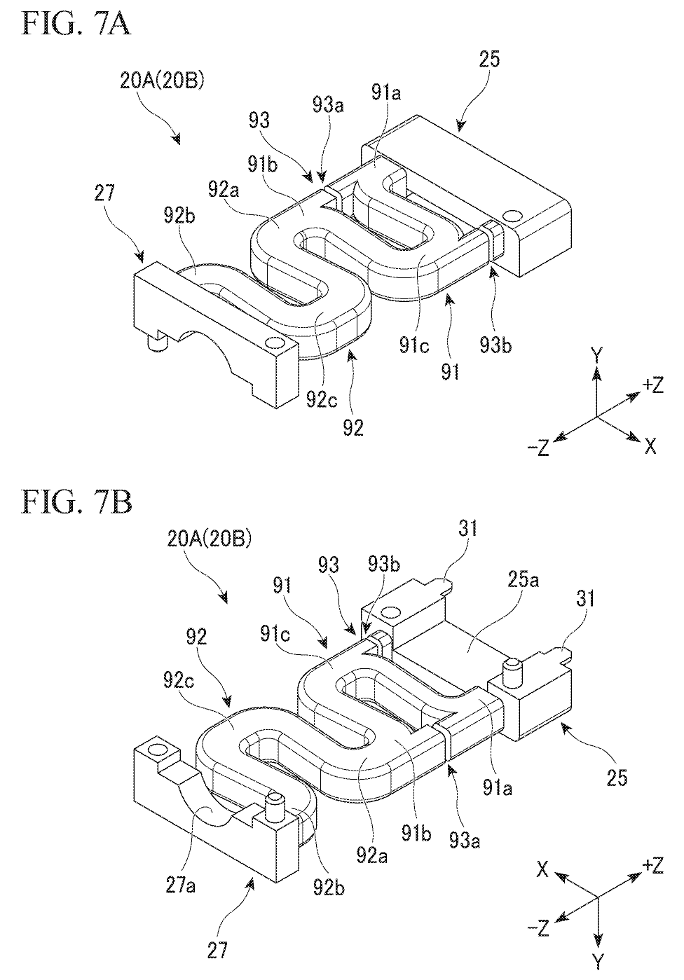

In the present example, the shape of the biasing member 20 is different from that in the first example. Specifically, as shown in FIGS. 6, 7A, and 7B, in the present example, each of the first member 20A and the second member 20B of the biasing member 20 has the tip portion 25, a first elastic portion 91 (an elastic portion) and a second elastic portion 92 having different spring constants, and the base end portion 27. The tip portion 25, the first elastic portion 91, the second elastic portion 92, and the base end portion 27 are integrally formed. Since the configurations of the tip portion 25 and the base end portion 27 are the same as those in the first example, the description thereof will be omitted here.

Each of the elastic portions 91 and 92 has a wave shape. The first elastic portion 91 and the second elastic portion 92 are disposed side by side in the longitudinal direction Z. The biasing portion 22 is configured by the elastic portions 91 and 92 of the first member 20A and the second member 20B. In the example shown in the drawings, the first elastic portion 91 is disposed on the tip side with respect to the second elastic portion 92. However, the first elastic portion 91 may be disposed on the base end side with respect to the second elastic portion 92.

The second elastic portion 92 has a higher spring constant than the first elastic portion 91. For example, by making the thickness of the second elastic portion 92 thicker than that of the first elastic portion 91, the spring constant of the second elastic portion 92 can be made higher than that of the first elastic portion 91.

The first elastic portion 91 is elastically deformable in the longitudinal direction Z. The first elastic portion 91 includes a first connection portion 91a that is connected to the tip portion 25, a second connection portion 91b that is connected to the second elastic portion 92, and a curved portion 91c that is disposed between the first connection portion 91a and the second connection portion 91b and curved in a wave shape (for example, a sinusoidal wave shape) along a plane orthogonal to the second direction Y. In the first member 20A (the second member 20B), the first connection portion 91a and the second connection portion 91b are disposed on one side in the first direction X. The curved portion 91c is curved to protrude toward the other side in the first direction X.

The second elastic portion 92 is elastically deformable in the longitudinal direction Z. The second elastic portion 92 includes a first connection portion 92a that is connected to the second connection portion 91b of the first elastic portion 91, a second connection portion 92b that is connected to the base end portion 27, and a curved portion 92c that is disposed between the first connection portion 92a and the second connection portion 92b and curved in a wave shape (for example, a sinusoidal wave shape) along a plane orthogonal to the second direction Y. In the first member 20A (the second member 20B), the first connection portion 92a and the second connection portion 92b are disposed on one side in the first direction X. The curved portion 92c is curved to protrude toward the other side in the first direction X.

In addition, each of the first member 20A and the second member 20B has a deformation restriction portion 93 for restricting the elastic deformation (compression) of a predetermined amount or more of the first elastic portion 91. In the example shown in the drawings, the deformation restriction portion 93 includes a first restriction portion 93a provided on one side in the first direction X, and a second restriction portion 93b provided on the other side in the first direction X, in the first member 20A (the second member 20B). The first restriction portion 93a is composed of a pair of restriction pieces that protrude in a direction in which the first connection portion 91a and the second connection portion 91b approach each other. The second restriction portion 93b is composed of a pair of restriction pieces that protrude in a direction approaching each other from the curved portion 91c and the tip portion 25.

In a state where the elastic deformation of the first elastic portion 91 is smaller than a predetermined amount, the pair of restriction pieces are separated from each other in each of the first restriction portion 93a and the second restriction portion 93b. In a case where the elastic deformation of the first elastic portion 91 reaches the predetermined amount, the pair of restriction pieces come into contact with each other in each of the first restriction portion 93a and the second restriction portion 93b. The pair of restriction pieces of the first restriction portion 93a come into contact with each other, and thus the first connection portion 91a and the second connection portion 91b are restricted from approaching each other. The pair of restriction pieces of the second restriction portion 93b come into contact with each other, and thus the curved portion 91c and the tip portion 25 are restricted from approaching each other. In this way, the elastic deformation of a predetermined amount or more of the first elastic portion 91 is restricted. Even in this case, the second elastic portion 92 continues the elastic deformation. That is, each of the first member 20A and the second member 20B is configured such that the first elastic portion 91 first completes the elastic deformation and then the second elastic portion 92 continues the elastic deformation.

In a stage where the first elastic portion 91 and the second elastic portion 92 start to be elastically deformed, the spring constant of the entire biasing member 20 (biasing portion 22) is a value obtained by combining the spring constants of the first elastic portion 91 and the second elastic portion 92. In a case where the elastic deformation progresses, the elastic deformation of the first elastic portion 91 is restricted by the deformation restriction portion 93, and thereafter, the spring constant of the second elastic portion 92 becomes the spring constant of the entire biasing member 20. That is, the spring constant of the entire biasing member 20 changes according to the compression length of the entire biasing member 20. In this way, the biasing force of the biasing member 20 (biasing portion 22) can be made small in a stage where the first elastic portion 91 and the second elastic portion 92 start to be elastically deformed, and can be made large after the first elastic portion 91 completes the elastic deformation (that is, after the elastic deformation of the first elastic portion 91 is restricted by the deformation restriction portion 93).

Here, in a case where the optical connector 1 is connected to another connector, a state at a point in time when the contact between the connection end surface 10a of the optical connector 1 and the connection end surface of the other connector starts is referred to as a "contact start state". In addition, a state where the connection between the optical connector 1 and the other connector is completed is referred to as a "connected state". In the connected state, in order to stabilize the connection between the optical fibers of the optical connector 1 and the other connector, the ferrule 10 of the optical connector 1 and the ferrule of the other connector are pressed against each other with a predetermined pressing force.

In the contact start state, it is preferable that the biasing force acting on the ferrule 10 is as small as possible. On the other hand, in a case where the biasing force acting on the ferrule 10 in the connected state is small, the connection between the optical connector 1 and the other connector becomes unstable. In addition, the biasing force acting on the ferrule 10 in the connected state is determined by a standard (for example, 10 N in the case of an MPO connector) and may not be changed. Therefore, it is not preferable to simply reduce the biasing force that is generated by the biasing member 20.

In the present example, each of the first member 20A and the second member 20B has the first elastic portion 91 and the second elastic portion 92 having a spring constant higher than that of the first elastic portion 91, and is configured such that the first elastic portion 91 first completes elastic deformation and then the second elastic portion 92 continues the elastic deformation. According to this configuration, it is possible to make the biasing force of the biasing member 20 small in a stage where the first elastic portion 91 and the second elastic portion 92 start to be elastically deformed (the contact start state), and to make the biasing force of the biasing member 20 large after the first elastic portion 91 completes the elastic deformation (the connected state).

Note that the technical scope of the present invention is not limited to the above-described embodiments, and various modifications can be made within a scope which does not depart from the gist of the present invention.

For example, the shapes of the first member 20A and the second member 20B may be appropriately changed. For example, the biasing member 20 (the first member 20A and the second member 20B) may be divided along a plane orthogonal to the first direction X, and the first member 20A and the second member 20B may be disposed such that the plurality of optical fibers F are sandwiched therebetween in the first direction X. In this case, the elastic portions 26, 91, and 92 may be curved in a wave shape (for example, a sinusoidal wave shape) along a plane orthogonal to the first direction X.

In the first example, each of the first member 20A and the second member 20B may have a plurality of elastic portions 26.

In the second example, each of the first member 20A and the second member 20B may have a plurality of first elastic portions 91 and may have a plurality of second elastic portions 92. In addition, each of the first member 20A and the second member 20B may further include a third elastic portion having a spring constant different from the spring constants of the first elastic portion 91 and the second elastic portion 92.

In the second example, the configuration of the deformation restriction portion 93 is not limited to the above as long as it is possible to restrict the elastic deformation (compression) of a predetermined amount or more of the first elastic portion 91. For example, the deformation restriction portion 93 may be provided at a central portion in the first direction X. The first restriction portion 93a may be configured with a single restriction piece extending from one of the first connection portion 91a and the second connection portion 91b toward the other. The second restriction portion 93b may be configured with a single restriction piece extending from one of the curved portion 91c and the tip portion 25 toward the other.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

What is claimed is:

1. An optical connector comprising:
a ferrule having a connection end surface and a fiber hole on the connection end surface;
an optical fiber inserted into the fiber hole;
a biasing member that generates a biasing force against the ferrule, wherein the optical fiber is inserted into the biasing member; and
a housing accommodating a part of the ferrule and the biasing member, wherein
the biasing member includes a first member and a second member engaged with the first member, and
each of the first member and the second member has a first wave-shaped elastic portion.

2. The optical connector according to claim 1, further comprising:
a guide pin inserted into the ferrule, wherein
the biasing member has a pin clamp portion that clamps the guide pin,
each of the first member and the second member has a tip portion that constitutes the pin clamp portion, and
the tip portion is integral with the first wave-shaped elastic portion.

3. The optical connector according to claim 1, wherein the first wave-shaped elastic portion includes resin or metal.

4. The optical connector according to claim 1, wherein a shape of the first member is identical to a shape of the second member.

5. The optical connector according to claim 1, wherein
each of the first member and the second member further includes a second wave-shaped elastic portion having a spring constant higher than a spring constant of the first wave-shaped elastic portion, and
after the first wave-shaped elastic portion completes elastic deformation, the second wave-shaped elastic portion continues the elastic deformation.

6. A method for manufacturing an optical connector, comprising:
inserting an optical fiber into a fiber hole of a ferrule;
polishing an end surface of the ferrule; and
after the polishing, disposing a first member and a second member such that the first member and the second member sandwich the optical fiber and the first member engages the second member, wherein each of the first member and the second member has a wave-shaped elastic portion.
